(19) United States
(12) Patent Application Publication
(10) Pub. No.: US 2014/0310653 A1
(43) Pub. Date: Oct. 16, 2014

(54) DISPLAYING HISTORY INFORMATION FOR APPLICATION

(71) Applicant: Samsung Electronics Co., Ltd., Gyeonggi-do (KR)

(72) Inventor: Kapsu HAN, Middlesex (GB)

(73) Assignee: Samsung Electronics Co., Ltd., Gyeonggi-do (KR)

(21) Appl. No.: 14/249,620

(22) Filed: Apr. 10, 2014

(30) Foreign Application Priority Data
Apr. 10, 2013 (GB) 1306493.6

(51) Int. Cl. G06F 3/0482

(52) U.S. Cl. CPC G06F 3/0482
USPC 715/810

(57) ABSTRACT

A device and a method of controlling a device are disclosed. At least one selection area is displayed and a first input selecting a first selection area is detected. An application corresponding to the first selection area may be executed, in response to the first input selecting the first selection area in a first manner. Usage history information associated with the application corresponding to the first selection area may be displayed, in response to the first input selecting the first selection area in a second manner.

### CLAIM OF PRIORITY

This application claims priority under 35 U.S.C. §119(a) to an application filed in the United Kingdom Intellectual Property Office on Apr. 10, 2013 and assigned Serial No. 1306493.6, the entire content of which is incorporated herein by reference.

### BACKGROUND

1. Field

The present disclosure relates to displaying history information for a selected action. In particular, the present disclosure relates to displaying one or more history items associated with a predetermined action, in response to input selecting the action.

2. Description of the Related Art

Many devices, including various consumer electronic devices such as laptop, desktop, or tablet computers, mobile telephones, personal digital assistant, and connected appliances, are capable of performing a variety of different functions. A user controls the device by selecting an action to be performed through a user interface. The action may be to perform a particular function, for example initiating a telephone call or sending an email, or to launch a software application such as an internet browser or media player. To enable a user to efficiently select a task to be performed, devices are often arranged to store a history of recent activity associated with a particular action. For example, the device may keep a record of recently dialed contacts, or the addresses of recently visited web pages. To access the history information associated with a particular application, for example a web browser, the user must launch the application and navigate through a number of menu screens to view the history and select the desired web address.

### SUMMARY

In view of the foregoing problems, disclosed herein are a method, non-transitory computer readable medium, and device for displaying usage history information associated with an application of a device.

In one aspect of the present disclosure, the method may comprise displaying at least one selection area; detecting a first input selecting a first selection area; in response to the first input selecting the first selection area in a first manner, executing an application corresponding to the first selection area; and in response to the first input selecting the first selection area in a second manner, displaying usage history information associated with the application corresponding to the first selection area.

In another aspect, the method may comprise obtaining ranking information associated with a plurality of history items included in the history information, the ranking information comprising information for ordering the plurality of history items in accordance with predetermined criteria; and ordering the plurality of history items based on the obtained ranking information. In a further aspect, the method may further comprise detecting a second input selecting a displayed history item included in the history information.

In another example, detecting the second input may comprise detecting a movement in a first direction or a second direction opposite to the first direction while the first input continues to select the first selection area such that a plurality of history items are scrolled to a first history item or a second history item adjacent to a currently selected history item, in accordance with the direction of the detected movement.

In yet another example, scrolling the plurality of history items may comprise displaying an indicator of the currently selected history item, and moving the displayed indicator to the first history item or the second history item in accordance with the direction of the detected movement.

Moreover, in a further example, scrolling the plurality of history items may comprises replacing the currently selected history item with the first history item adjacent to the currently selected history item or the second history item adjacent to the currently selected history item, in accordance with the direction of the detected movement.

In a further aspect of the present disclosure, the method may further comprise detecting a third input; and performing a first predetermined action for a currently selected history item in response to the third input. In yet a further aspect, the method may comprise detecting a fourth input; and performing a second predetermined action for the currently selected history item in response to the fourth input. In another example, detecting the third input may comprise detecting a movement in a third direction and detecting the fourth input comprises detecting a movement in a fourth direction direction opposite to the third direction.

In yet a further aspect of the present disclosure, the method may further comprise detecting movement using one of a touch-sensitive display, an eye-tracking interface, a tilt sensor, an accelerometer, or a motion-recognition interface. The electronic device may be a mobile telephone, laptop computer, personal computer, tablet computer, personal digital assistant, or an appliance connected thereto.

In another example, the method may further comprise detecting input using one of a key-based interface, a touchscreen interface, a voice-recognition interface, a motion-recognition interface, a tilt sensor, an accelerometer, and an eye-tracking interface. Furthermore, the usage history information may be stored in a common memory accessible by one or more processor.

In addition, a non-transitory computer readable medium may have instructions stored therein which upon execution may cause at least one processor to: display at least one selection area; detect a first input selecting a first selection area; in response to the first input selecting the first selection area in a first manner, execute an application corresponding to the first selection area; and in response to the first input selecting the first selection area in a second manner, display usage history information associated with the application corresponding to the first selection area.

In yet a further aspect of the present disclosure a device is provided such that the device comprises: a display; an input module configured to detect input; and a controller configured to: detect a first input selecting a first selection area; execute an application corresponding to the first selection area, in response to the first input selecting the first selection area in a first manner; and display usage history information associated with the application corresponding to the first selection area, in response to the first input selecting the first selection area in a second manner.

### BRIEF DESCRIPTION OF THE DRAWINGS

Examples of the present disclosure will now be described with reference to the accompanying drawings, in which:

FIG. 1 illustrates an example device in accordance with aspects of the present disclosure;

FIG. 2 schematically illustrates components included in an example device of FIG. 1;

FIG. 3A, FIG. 3B, FIG. 3C and FIG. 3D illustrate an example user interface in accordance with aspects of the present disclosure;

FIG. 4A and FIG. 4B illustrate a working example of scrolling through a plurality of displayed history items in accordance with aspects of the present disclosure;

FIG. 5 illustrates a working example of selecting an action to be performed for a selected history item in accordance with aspects of the present disclosure;

FIG. 6 illustrates a working example of selecting a different action in response to fourth input in accordance with aspects of the present disclosure;

FIG. 7 illustrates an example method of controlling a device in accordance with aspects of the present disclosure;

FIG. 8 illustrates a working example of tilting a device to scroll through a plurality of history items in accordance with aspects of the present disclosure;

FIG. 9 illustrates an example method of selecting one of a plurality of history items in accordance with aspects of the present disclosure;

FIG. 10A, FIG. 10B, FIG. 10C and FIG. 10D illustrate an example a user interface in accordance with aspects of the present disclosure; and

FIG. 11A, FIG. 11B, FIG. 11C and FIG. 11D illustrate a further example user interface in accordance with aspects of the present disclosure.

### DETAILED DESCRIPTION

Various embodiments will now be described more fully with reference to the accompanying drawings in which some embodiments are shown. Therefore, it should be understood that there is no intent to limit the embodiments to the particular forms disclosed, but on the contrary, it is intended that the embodiments are to cover all modifications, equivalents, and alternatives falling within the scope of the invention.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application is for the purpose of describing particular embodiments only and is not intended to be limiting. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. Such terms as those defined in a generally used dictionary are to be interpreted to have the meanings equal to the contextual meanings in the relevant field of art, and are not to be interpreted to have ideal or excessively formal meanings unless clearly defined in the present specification.

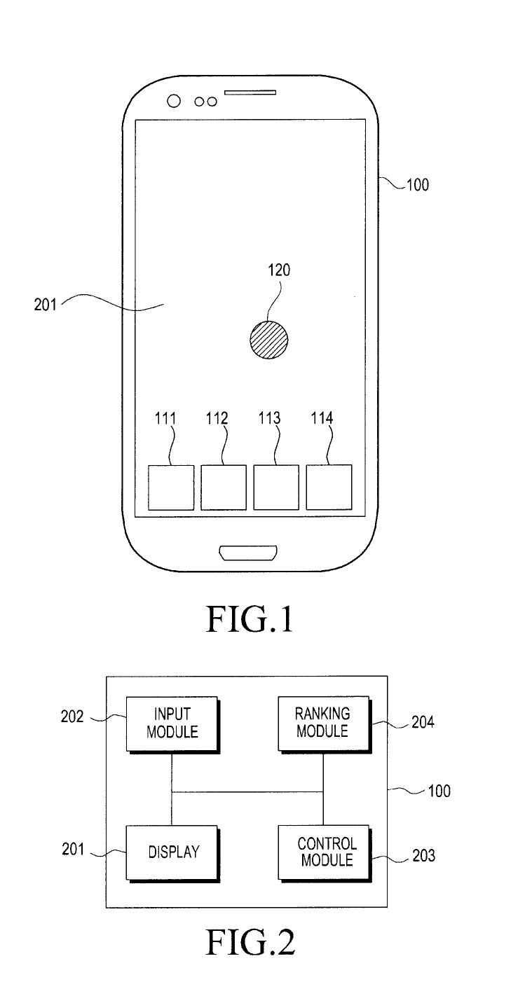

Referring now to FIGS. 1 and 2, an example device to display a plurality of selection areas is shown. The plurality of selection areas may be a plurality of application icons. The device 100 may comprise a display 201, input module 202, control module 203, and ranking module 204. In the present example the device 100 is a mobile telephone including a touch-sensitive display 201, and may also be referred to as a smartphone. In other examples however the device could be, for example, a laptop computer, personal computer, tablet computer, personal digital assistant, or an appliance connected thereto.

As shown in FIG. 1, a user interface (UI) may be displayed including a plurality of selection areas 111, 112, 113, 114. In the present example four selection areas are displayed, but in general any number of selection areas may be displayed. The selection areas 111, 112, 113, 114 may be displayed in various ways, such as application icons, tiles, images and/or text. Each selection area may be an area which may be selected by contact point 120 detected through the input module 202 to cause the device 100 to perform a predetermined action. Examples of actions which may be selected by a selection area include, but are not limited to, initiating a call, text or multimedia messaging function, launching an application such as an internet browser, music player, video player, search engine, image gallery, document viewer, map application, email application, and so on. Each selection area may be a visual object such as an icon, an item, or the like.

In the present example, the input module 202 may detect input by detecting and locating a contact point 120 on a touch-sensitive display, which may also be referred to as a touchscreen. For example, at least part of the input module 202 may be included in the display 201, and at least part of the display 201 and the input module 202 may correspond to a touchscreen or a touch panel (or a touch interface). For example, the display 201 may be a display panel such as a Liquid Crystal Display (LCD), an Organic Light Emitting Diode (OLED), an LED, or the like, and the input module 202 may be a resistive type touch panel, a capacitive type touch panel, an ElectroMagnetic (EM) type touch panel, an ElectroMagnetic Resonance (EMR) type touch panel, or a combination thereof.

In this example, a user may select one of the selection areas 111, 112, 113, 114 by touching the appropriate selection area on the display 201. However, other types of user interfaces are known and the input module is not limited to receiving input through a touchscreen interface. Examples of other types of user interfaces that may be used, include, but are not limited to, a key-based interface, a voice-recognition interface, a motion-recognition interface, a tilt-sensitive interface, and an eye-tracking interface. For example, the display 201 may be a touchscreen, and the input module 202 may include one or more user interface such as buttons, a keypad, a microphone, a camera, a motion sentor, or the like. A user input through through a touchscreen interface may be contact or hovering of a touch means such as a finger or a pen.

Continuing with reference to FIGS. 1 and 2, the control module 203 may control the display 201 to display the selection areas 111, 112, 113, 114 and to detect a first input through the input module 202. When the first input selects a first selection area, the device 100 may monitor a time for which the first input continues to select the first selection area 111. For example, when the input module 202 detects the first input through the touchscreen interface, the first selection area 111 may be selected when a contact point 120 is detected within the boundary of the first selection area 111. The device 100 may monitor the time for which the detected contact point 120 remains within the boundary of the first selection area 111. When the contact is released, the device may consider the selection area to be no longer selected.

In response to the first input selecting the first selection area 111 for less than a predetermined time period, the control module 203 may control the device 100 to perform a first predetermined action selected by (or corresponding to) the first selection area 111. Here, the first predetermined action may be the default action which is performed in response to the first selection area 111 being selected. However, if the first input continues to select the first selection area 111 past the predetermined time period, then the control module 203 controls the display 201 to display one or more selectable history items associated with the first predetermined action. In examples which detect the first input through a touchscreen interface, selecting a selection area for less than the predetermined time period may be referred to as a ‘short press’, whilst input selecting the selection area for more than the predetermined time period may be referred to as a ‘long press’. Depending on the example, in response to selecting the selection area for a time equal to the predetermined time period, the device may either perform the default action or display the history items. That is, the condition on which the history items are displayed may either be defined as a ‘greater than’ condition, or a ‘greater than or equal to’ condition. The control module 203 may be referred to as a controller, a control unit or a processor.

Also, in the present example, the device 100 further comprises a ranking module 204. When a plurality of history items are to be displayed, the ranking module 204 may obtain ranking information associated with the plurality of history items. The ranking module 204 may use the obtained ranking information to order the plurality of history items in accordance with predetermined criteria. For example, the history items may be ordered in accordance with how frequently each item has been accessed, or in accordance with how recently each item was last accessed.

The selectable history items may provide history information associated with the default action selected by (or corresponding to) the selection area. The type of history item displayed may depend on the type of action that is selected by the first selection area. Examples of history items associated with different types of action are shown below in Table 1.

TABLE 1

| SELECTED ACTION | TYPE OF HISTORY ITEM |
|---|---|
| Call function | Previously dialled contacts |
| Text/multimedia messaging function | Previously messaged contacts |
| Launch music player | Previously accessed music files |
| Launch video player | Previously accessed video files |
| Launch search engine application | Search history terms |
| Launch web browser application | Previously visited web addresses |
| View image gallery | Previously viewed images |
| Launch document viewer | Previously loaded documents |
| Launch map application | Previous locations |
| Launch navigation application | Previous destinations |
| Launch FM radio | Previously tuned frequencies |
| Launch email application | Sent/received email history |

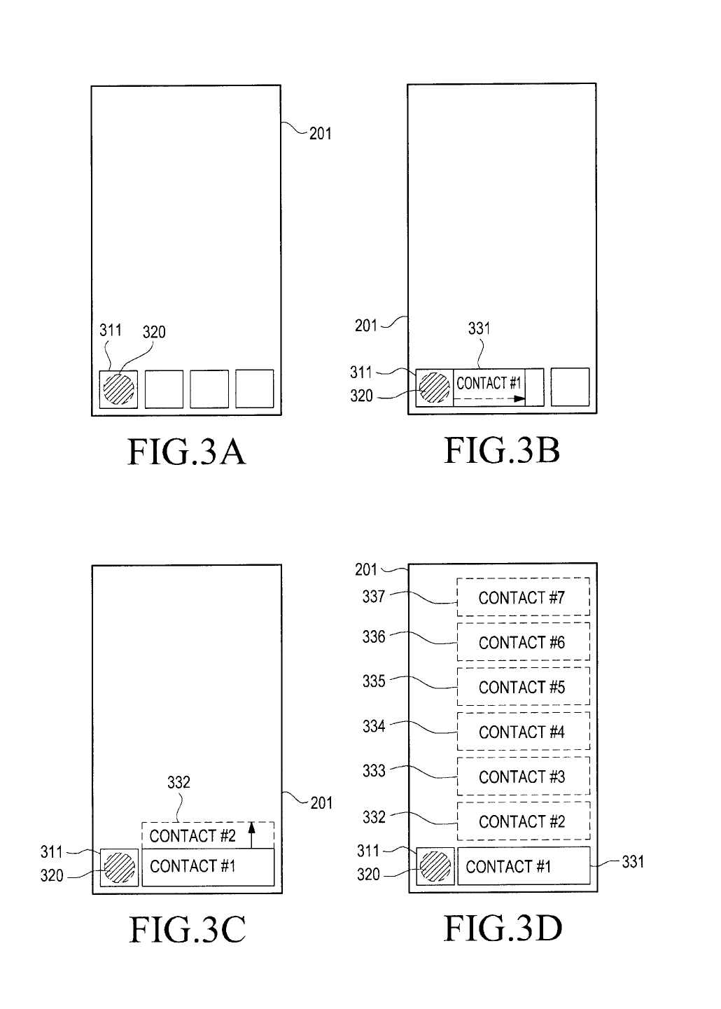

A UI displayed by the device 100 of FIGS. 1 and 2 will now be described with reference to FIGS. 3A to 3D. First, a plurality of selection areas are displayed as shown in FIG. 1. Then, as shown in FIG. 3A, first input 320 may be detected selecting a first selection area 311. In the present example, the first input 320 may be a contact event detected by the touchscreen within the boundary of the first selection area 311.

In response to the first input 320 continuing to select the first selection area 311 for longer than the predetermined time period, a plurality of history items may be displayed as shown in FIGS. 3B to 3D. The first selection area 311 may be a selection area for selecting a call function, and the history items may be recently dialed contacts from a stored list of contacts in the device, but in other examples other actions and other types of history items may be used. In the present example, the history items are displayed as follows. First, as shown in FIG. 3B, a first history item 331 may slide out from first selection area 311 to a predefined limit in an animated fashion such that first selection area 111 may overlap other selection areas. Then, as shown in FIG. 3C, a second history item 332 may be slide out, also in an animated fashion, vertically from first history item 331 to a predefined location above first history item 331. Other history items 333, 334, 335, 336, 337 may continue to be displayed in a similar manner until a predetermined number of history items are displayed, as shown in FIG. 3D, or until all available history items are displayed. The order of the history items may be determined by the ranking module based on the obtained ranking information. The ranking module 204 may be included in the control module 203

In some examples, the manner in which the first selection area is displayed may be changed to indicate that a long press, or other type of input, has been detected. For example, the appearance of the first selection area may be altered when a long press is detected by changing the shape, colour and/or transparency of the first selection area.

The control module may also control the display to indicate which one of the plurality of history items is currently selected, by displaying the currently selected history item differently than other history items. The currently selected history item may be the item on which an action will be performed in response to subsequent input. In the present example, the first history item 331, which may be the highest-ranked history item, may be selected by default after the plurality of history items 331, 332, 333, 334, 335, 336, 337 have been displayed. In FIG. 3D, the currently selected history item is displayed as opaque, while other history items are displayed at a predetermined transparency, for example 50%, to indicate which item is currently selected. However, other display methods could be used to distinguish between selected and non-selected history items in other examples. For example, all history items could be displayed with the same transparency, and the currently selected history item could be highlighted and/or displayed at a different size than that of the non-selected history items.

Conventional methods may require a user to first select an action or application and then navigate through various menu screens to access history information. However, the examples disclosed herein may allow the user to select the action to be performed and review the history for that action with only a single input without navigating additional menu screens. Power consumption may therefore be reduced, because only a single input may be required and the device does not have to waste processing time and power by displaying the intervening menu screens that would normally be required in conventional devices.

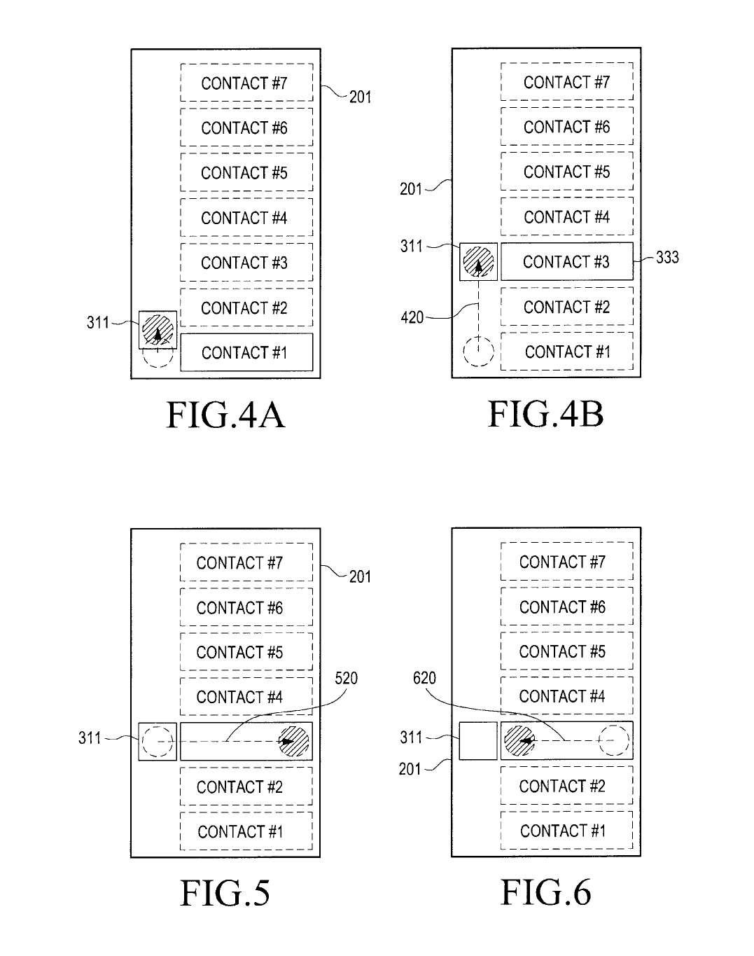

A method of controlling the device to select a different history item will now be described with reference to FIGS. 4A and 4B. To select one of the displayed history items, the control module may further detect a second input 420 via the input module after at least some of the plurality of history items have been displayed.

In the present example, the input module may detect the second input 420 by detecting movement of the contact point away from the first selection area in a first direction or a second direction. In other examples, the input module may, for example, detect the movement in the first direction or the second direction by detecting eye movement through an eye-tracking interface, and/or detecting movement of the device through a tilt sensor, and/or detecting motion through a motion-recognition interface. In accordance with the direction of the detected movement, the control module may scroll through the plurality of history items to a first history item or a second history item adjacent to a currently selected history item.

Here, the second input 420 may be detected while the user is still touching the first selection area on the touchscreen, that is, while the first input continues to select the first selection area. This allows the first and second input to be detected as different elements of the same contact event. In other words, the user may provide the first and second input in a single gesture by holding the first selection area for the predetermined time period and then moving in the first or second direction to select the desired history item. However, in another example, the user may release the first selection area after the history items have been displayed such that the input module detects the second input when the first selection area is no longer selected. In the present example, the first selection area is moved along with the contact point, however, the first selection area may be fixed.

In the present example, the control module may control the display to display the plurality of ordered history items in an order determined by the ranking module; scroll through the plurality of history items by controlling the display to display an indicator of the currently selected history item; and move the displayed indicator to the first adjacent history item or the second adjacent history item based on the direction of the detected movement. The use of an indicator may be particularly advantageous when a non-contact user interface is used. When using the non-contact user interface such as an eye-tracking interface or motion-recognition interface, the indicator can provide visual feedback to aid the user in scrolling through the history items.

Displaying the indicator may comprise displaying the currently selected history item differently than non-selected history items, as described above with reference to FIG. 3D. For example, the transparency and/or colour of a selected history item may be changed when the item is selected or deselected. In addition, in the present example, the first selection area is used as a separate indicator by moving the first selection area along the displayed list of history items. However, in other examples, the first selection area may remain fixed or may not be displayed at all, and a separate indicator may be moved along the displayed list of history items. Alternatively, the indicator itself may be omitted, for instance, the device could provide an audible indication of the currently selected history item instead of displaying a visual indicator. By way of example, when the plurality of history items include contacts from a phone book, address book, or other source of contacts, the device may use a speech synthesizer to convert the name of the currently selected contact to speech and reproduce the obtained speech through a speaker. The speech synthesizer could be included in the device as a software or hardware module, or could be accessed remotely, for example over the Internet.

FIGS. 5 and 6 illustrate working examples of selecting different actions to be performed for the currently selected history item, in accordance with aspects of the present disclosure. The device may respond to a third input 520, after the history items have been displayed, by performing the first predetermined action for the currently selected history item. The first predetermined action may be the default action selected by the first selection area. In response to the third input being detected through the input module, the control module may control the device to perform the first predetermined action for the currently selected history item. Alternatively, a user may provide a fourth input 620 to select a second predetermined action. For example, if the first predetermined action initiates a telephone call to the selected contact, the second predetermined action may be to open a message composition screen to compose a new text message to the selected contact.

As shown in FIG. 5, the third input 520 may be detected by detecting movement of the contact point in a third direction over the selected history item and detecting a release of the contact point at a defined area towards an end of the selected history item. Alternatively, instead of releasing the contact point at the defined area, which in FIG. 5 is the right-hand end of the selected history item, a user may provide a fourth input by dragging back towards the other end of the history item in a fourth direction, opposite to the third direction, and releasing the contact in a second defined area at the other end, as shown in FIG. 6.

Although in the present example the third input and fourth input are detected by detecting movement in a third direction and a fourth direction via a touchscreen interface, in other examples a non-contact method may be used to detect movement. For example, the input module may detect the movement in the third direction or the fourth direction by detecting eye movement through an eye-tracking interface, and/or detecting movement of the device through a tilt sensor and/or accelerometer, and/or detecting motion through a motion-recognition interface. In one example, the third input may be detected by detecting movement of the device in a direction to the left of the display, using an accelerometer, and the fourth input may be detected by detecting movement of the device in a direction to the right of the display. In this instance, a user may perform the first predetermined action or the second predetermined action for the selected history item by physically shaking the device to the left or to the right. In another example, the third direction may be the horizontal direction, such that the third input may be detected by detecting a shake of the device back and forth, and the fourth direction may be the vertical direction, such that the fourth input may be detected by detecting shaking of the device up and down. Alternatively, the third and/or fourth input could be detected without detecting movement, for example by using a voice-recognition interface.

A user interface such as the one described above with reference to FIGS. 3A to 3D, 4A, 4B, 5 and 6, may enable a user to efficiently select an action to be performed, review history information for the selected action, and select a particular history item to be used, all within a single input gesture and without having to wait for the action to be performed.

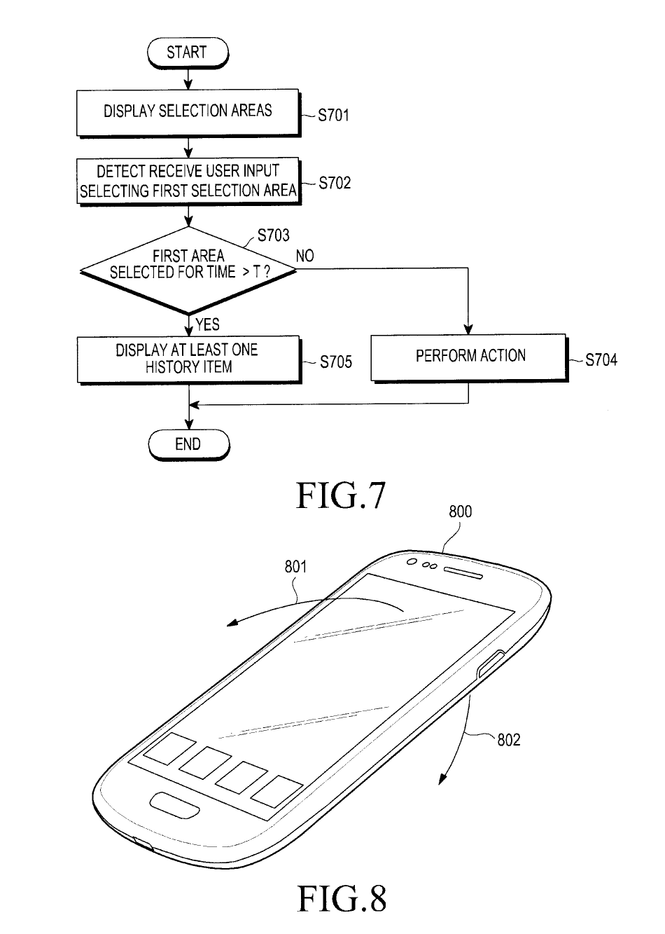

Referring now to FIG. 7, an example method of controlling a device is illustrated in accordance with aspects of the present disclosure. The method may be used to display history items, for example in a UI as described above with reference to FIGS. 3A to 3D. First, at block S701, one or more selection areas may be displayed. Then, at block S702, a first input selecting a first selection area may be detected. Next, at block S703, the device may identify whether the first selection area has been selected for longer than a predetermined time period. If the first selection area is deselected before the predetermined time period has elapsed, the device may perform a first predetermined action, at block S704. However, if the first input selects the first selection area for more than the predetermined time period the device may display at least one history item associated with the first predetermined action at block S705.

Referring now to FIG. 8, an example device is illustrated. In this example, the device 800 may detect a second input for selecting one of the history items by detecting a movement using a tilt sensor. The control module may select a first history item adjacent to the currently selected history item in response to a movement detected in the first direction 801, and may select a second history item adjacent to the currently selected history item in response to movement being detected in a second direction 802. Either movement in the first direction 801 and second direction 802 may be regarded as the second input. The first direction 801 and second direction 802 may also comprise a rotation in opposite directions about a predetermined axis.

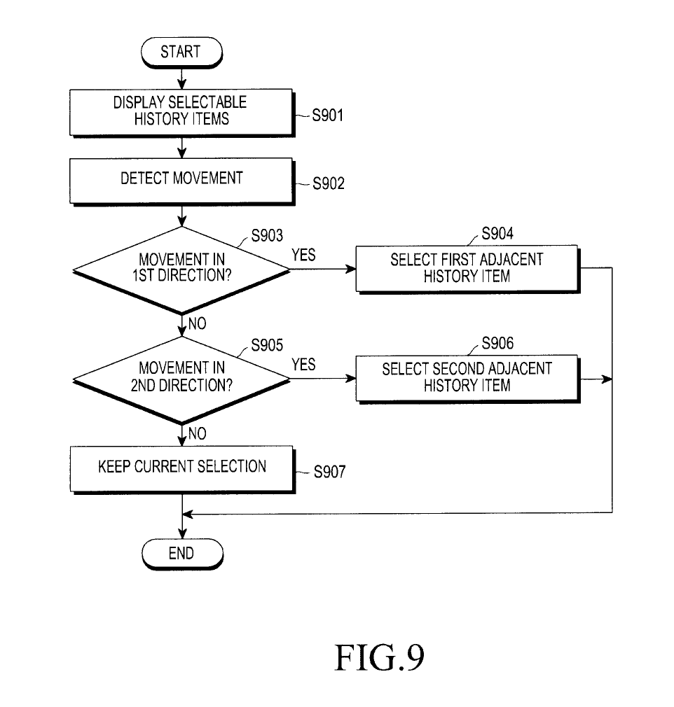

Referring now to FIG. 9, a method of controlling a device is illustrated in accordance with aspects of the present disclosure. First, at block S901, a plurality of selectable history items may be displayed. At block S902, a second input may be detected. At block S903, the device may identify whether the detected movement is in the first direction. If the movement is in the first direction, the first adjacent history item may be selected at block S904. If the movement is not in the first direction, the device may identify whether the detected movement is in the second direction at block S905. If the movement is in the second direction, the second adjacent history item may be selected at block S906. On the other hand, if the detected movement is neither in the first or second direction, the currently selected history item may be retained as the current selection at block S907.

Selecting the first adjacent history item or the second adjacent history item may comprise scrolling through the plurality of history items to the first or second history adjacent to the currently selected item based on a direction of the detected movement. The scrolling may be carried out by changing an indicator of the currently selected history item as shown in FIGS. 4A and 4B.

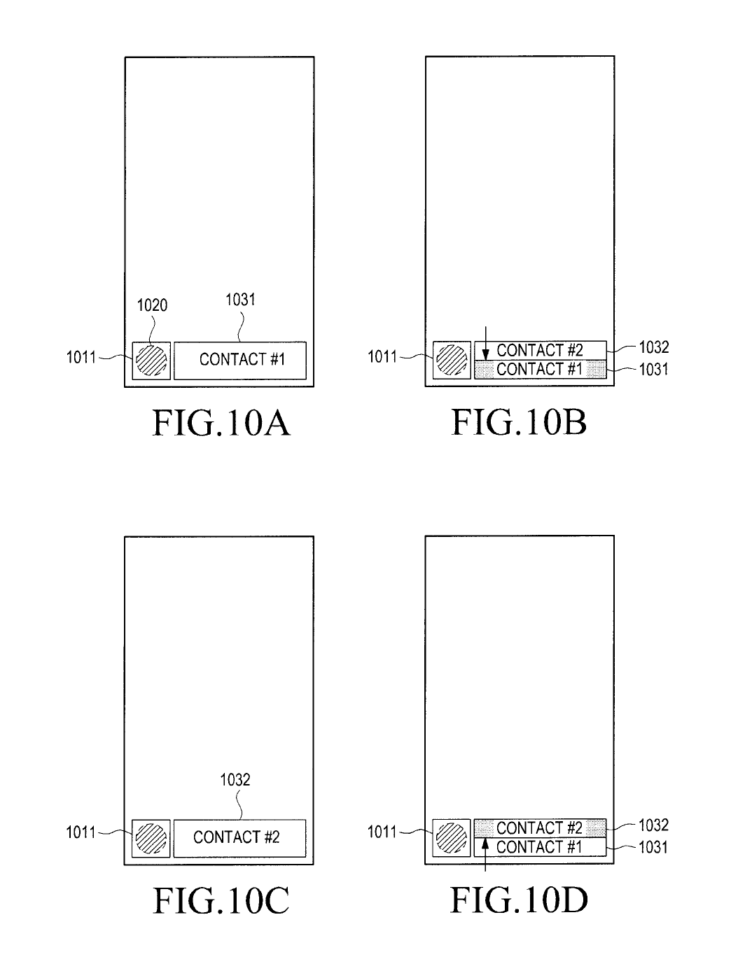

Referring now to FIGS. 10A to 10D, a user interface is illustrated in accordance with a further example of the present disclosure. The user interface may be used as an alternative to that shown in FIGS. 4A and 4B, to allow a user to scroll through a plurality of history items by only displaying one history item at a time.

As shown in FIG. 10A, a first history item 1031 may be displayed in response to first input 1020 selecting a first selection area for longer than a predetermined time period. However, unlike in FIGS. 3C and 3D, only the first history item 1031 may be displayed, even though other history items are available. In response to second input (e.g., a downward drag gesture) being detected while the first input 1020 continues to select the first selection area, the control module of the device controls the display to replace the displayed first history item with a first adjacent history item or a second adjacent history item, in accordance with the second input. The second input may be detected by detecting a movement in a first direction or a second direction, and the control module may control the display to replace the first history item with the first adjacent history item or the second adjacent history item, in accordance with the direction of the detected movement.

As shown in FIGS. 10B and 10C, the first adjacent history item 1032 may be animated so as to slide over the first history item 1031, which was the currently selected history item, until the first adjacent history item 1032 replaces the first history item. Although a sliding animation may be used in the present example when replacing one history item with another, it will be understood that in other examples the replacement of a history item could be displayed differently. For example, a different animation could be used, or the previous history item could be directly replaced with the next history item without any animation. As shown in FIG. 10D, the user may return to the first history item by scrolling in the other direction, for example by inputting the second input (e.g., a upward drag gesture) in the second direction instead of the first direction.

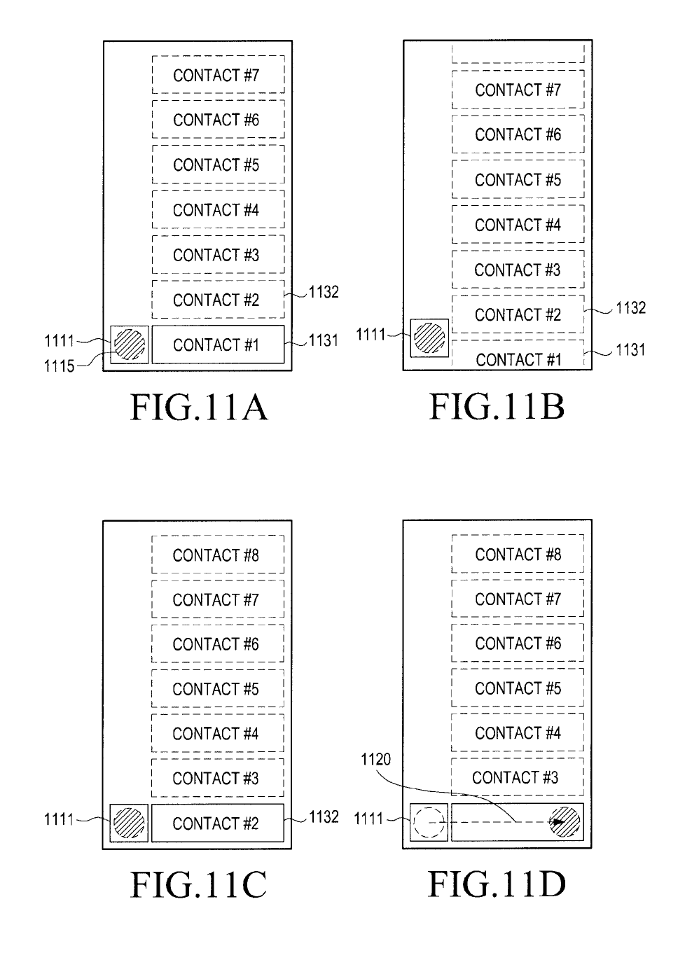

Referring now to FIGS. 11A to 11D, a user interface is illustrated in accordance with a further example of the present disclosure. The user interface may be used as an alternative to those shown in FIGS. 4A, 4B and 10A to 10D. As shown in FIG. 11A, a plurality of history items including a currently-selected history item 1131 and a first adjacent history item 1132 are displayed while a first input selects a first user selection area, in a similar manner to FIG. 3D. In response to second input (e.g., a downward drag gesture) being detected by detecting a movement in a first direction while the first input selects the first user selection area, the list of history items may be scrolled by shifting the entire list down by one position, as shown in FIGS. 11B and 11C. Thus, the previously-selected history item 1131 may be replaced with the first adjacent history item 1132 as the currently-selected history item.

In a similar manner to other above-described examples, the list of history items in FIGS. 11A to 11D could also be scrolled in the opposite direction in response to appropriate second input (e.g., a upward drag gesture) being detected. The second input may comprise detecting a movement in the second direction. For example, a user may provide the second input by tilting the device forward or backward, as shown in FIG. 5, while continuing to press the first selection area.

As shown in FIG. 11D, a user may then select a predetermined action to be performed for the currently-selected history item 1132 by inputting a third input 1120 in a similar manner to that described above for FIG. 5, or by inputting a fourth input (not shown in FIG. 11D) in a similar manner to that described for FIG. 6.

The user interface of FIGS. 11A to 11D may be similar to the interface shown in FIGS. 10A to 10D in that the history items are scrolled by replacing the previously selected history item with the next history item. However, the user interface of the present example differs from that shown in FIGS. 10A to 10D in that a plurality of non-selected history items are also displayed in addition to the currently-selected history item.

In some examples, a scrolling method such as the one illustrated in FIGS. 11A to 11C may be combined with a method such as the one shown in FIGS. 4A and 4B. Specifically, a device may display a plurality of history items as shown in FIG. 4A and scroll up and down the list by moving an indicator, as shown in FIG. 4B, and when one end of the displayed list is reached, the device may continue to scroll by moving the list while keeping the indicator stationary, as shown in FIG. 11B.

Examples of the present disclosure have been described in which one or more history items are displayed by a device. The device may store history items up to a predetermined limit. When a new history item is created which causes the limit to be exceeded, the oldest history item may be deleted to allow the newly-created history item to be stored. In devices which comprise a plurality of processors, a control module may store information relating to the one or more history items in a common memory accessible by each of the plurality of processors. This ensures that history items created or modified by one processor may be accessed by a different processor, if required.

Whilst certain examples of the disclosure have been described above, it will be understood that many variations and modifications will be possible without departing from the spirit and scope of the disclosure as defined in the appended claims.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

What is claimed is:

1. A method in an electronic device, the method comprising:
displaying at least one selection area;
detecting a first input selecting a first selection area;
in response to the first input selecting the first selection area in a first manner, executing an application corresponding to the first selection area; and
in response to the first input selecting the first selection area in a second manner, displaying usage history information associated with the application corresponding to the first selection area.

2. The method of claim 1, further comprising:
obtaining ranking information associated with a plurality of history items included in the history information, the ranking information comprising information for ordering the plurality of history items in accordance with predetermined criteria; and
ordering the plurality of history items based on the obtained ranking information.

3. The method of claim 1, further comprising detecting a second input selecting a displayed history item included in the history information.

4. The method of claim 3, wherein detecting the second input comprises detecting a movement in a first direction or a second direction opposite to the first direction while the first input continues to select the first selection area such that a plurality of history items are scrolled to a first history item or a second history item adjacent to a currently selected history item, in accordance with the direction of the detected movement.

5. The method of claim 4, wherein scrolling the plurality of history items comprises:
displaying an indicator of the currently selected history item; and
moving the displayed indicator to the first history item or the second history item in accordance with the direction of the detected movement.

6. The method of claim 4, wherein scrolling the plurality of history items comprises:
replacing the currently selected history item with the first history item adjacent to the currently selected history item or the second history item adjacent to the currently selected history item, in accordance with the direction of the detected movement.

7. The method of claim 3, further comprising:
detecting a third input based on a movement in a third direction or a fourth input based on a movement in a fourth direction opposite to the third direction;
performing a first predetermined action for a currently selected history item in response to the third input when the third input is detected; and
performing a second predetermined action for the currently selected history item in response to the fourth input when the fourth input is detected.

8. The method of claim 1, further comprising detecting movement using one of a touch-sensitive display, an eye-tracking interface, a tilt sensor, an accelerometer, or a motion-recognition interface.

9. The method of claim 1, further comprising detecting input using one of a key-based interface, a touchscreen interface, a voice-recognition interface, a motion-recognition interface, a tilt sensor, an accelerometer, and an eye-tracking interface.

10. A non-transitory computer-readable storage medium with instructions stored therein which upon execution cause at least one processor to:
display at least one selection area;
detect a first input selecting a first selection area;
in response to the first input selecting the first selection area in a first manner, execute an application corresponding to the first selection area; and
in response to the first input selecting the first selection area in a second manner, display usage history information associated with the application corresponding to the first selection area.

11. A device comprising:
a display;
an input module configured to detect input; and
a controller configured to:
detect a first input selecting a first selection area;
execute an application corresponding to the first selection area, in response to the first input selecting the first selection area in a first manner; and
display usage history information associated with the application corresponding to the first selection area, in response to the first input selecting the first selection area in a second manner.

12. The device of claim 11, wherein the controller is configured to:
obtain ranking information associated with a plurality of history items included in the history information, the ranking information comprising information for ordering the plurality of history items in accordance with predetermined criteria; and
order the plurality of history items based on the obtained ranking information.

13. The device of claim 11, wherein the controller is configured to detect a second input selecting a displayed history item included in the history information.

14. The device of claim 13, wherein the controller is configured to detect a movement in a first direction or a second direction opposite to the first direction while the first input continues to select the first selection area such that a plurality of history items are scrolled to a first history item or a second history item adjacent to a currently selected history item, in accordance with the direction of the detected movement.

15. The device of claim 14, wherein the controller is configured to:
display an indicator of the currently selected history item; and
move the displayed indicator to the first history item or the second history item in accordance with the direction of the detected movement.

16. The device of claim 14, wherein the controller is configured to replace the currently selected history item with the first history item adjacent to the currently selected history item or the second history item adjacent to the currently selected history item, in accordance with the direction of the detected movement.

17. The device of claim 13, wherein the controller is configured to:
detect a third input based on a movement in a third direction or a fourth input based on a movement in a fourth direction opposite to the third direction;
perform a first predetermined action for a currently selected history item in response to the third input when the third input is detected; and
performing a second predetermined action for the currently selected history item in response to the fourth input when the fourth input is detected.

18. The device of claim 11, wherein the controller is configured to detect movement using one of a touch-sensitive display, an eye-tracking interface, a tilt sensor, an accelerometer, or a motion-recognition interface.

19. The device of claim 11, wherein the controller is configured to detect input using one of a key-based interface, a touchscreen interface, a voice-recognition interface, a motion-recognition interface, a tilt sensor, an accelerometer, and an eye-tracking interface.

20. The device of claim 11, wherein the controller is configured to store the usage history information in a memory of the device.
